(19) United States
(12) Patent Application Publication
(10) Pub. No.: US 2023/0267538 A1
(43) Pub. Date: Aug. 24, 2023

(54) METHOD AND SYSTEM FOR PROXY EVENT VISUALIZATION

(71) Applicant: JPMorgan Chase Bank, N.A., New York, NY (US)

(72) Inventors: Nigel LUPTON, London (GB); Christian RHODES, Kidlington (GB); Donna HORDER, Ferndown (GB)

(73) Assignee: JPMorgan Chase Bank, N.A., New York, NY (US)

(21) Appl. No.: 17/651,984

(22) Filed: Feb. 22, 2022

(51) Int. Cl. G06Q 40/02; G06F 16/955; G06Q 10/06; G06Q 10/10; H04L 67/133

(52) U.S. Cl. CPC G06Q 40/025; G06F 16/9558; G06Q 10/0637; G06Q 10/1093; H04L 67/40

(57) ABSTRACT

A method for providing proxy event visualization is disclosed. The method includes aggregating, via an application programming interface, event data from various sources, the event data including information that relates to future proxy events; parsing the event data to identify an attribute that corresponds to each of the future proxy events, the attribute including a security identifier; mapping each of the future proxy events to client portfolios based on the attribute; generating a graphical element for each of the client portfolios, the graphical element including the information that relates to the future proxy events; and displaying, via a graphical user interface, the graphical element.

### BACKGROUND

### 1. Field of the Disclosure

This technology generally relates to methods and systems for event visualization, and more particularly to methods and systems for providing proxy event visualization via a graphical representation to facilitate analytics of upcoming corporate events.

### 2. Background Information

Many financial institutions manage large and diverse security portfolios for numerous clients. Often, the security portfolios are sensitive to environmental, social, and/or governance factors that are associated with corporate actions such as, for example, upcoming proxy events. Historically, implementations of conventional techniques for managing and analyzing the upcoming proxy events have resulted in varying degrees of success with respect to analytical efficiency and management effectiveness.

One drawback of implementing the conventional techniques is that in many instances, the security portfolios include a substantial number of different financial instruments with various sensitivities. As a result, impacts of the upcoming proxy events may not be effectively realized in a timely manner. Additionally, due to the large security portfolios, relevant information for decision makers may be spread across multiple systems and platforms.

Therefore, there is a need to provide proxy event visualization via a graphical representation that leverages a calendar view and aggregated event data to facilitate analytics of upcoming corporate events.

### SUMMARY

The present disclosure, through one or more of its various aspects, embodiments, and/or specific features or sub-components, provides, inter alia, various systems, servers, devices, methods, media, programs, and platforms for providing proxy event visualization via a graphical representation to facilitate analytics of upcoming corporate events.

According to an aspect of the present disclosure, a method for providing proxy event visualization is disclosed. The method is implemented by at least one processor. The method may include aggregating, via an application programming interface, event data from a plurality of sources, the event data may include information that relates to at least one future proxy event; parsing the event data to identify at least one attribute that corresponds to each of the at least one future proxy event, the at least one attribute may include a security identifier; mapping each of the at least one future proxy event to at least one client portfolio based on the at least one attribute; generating at least one graphical element for each of the at least one client portfolio, the at least one graphical element may include the information that relates to the at least one future proxy event; and displaying, via a graphical user interface, the at least one graphical element.

In accordance with an exemplary embodiment, the at least one future proxy event may relate to an upcoming corporate action, the upcoming corporate action may include a scheduled proxy vote.

In accordance with an exemplary embodiment, the at least one graphical element may include a visual representation of a plurality of days that is organized based on a predetermined preference, the visual representation may correspond to a calendar display format.

In accordance with an exemplary embodiment, the at least one graphical element may include at least one user selectable element for each of the at least one future proxy event that hyperlinks to at least one grid data view, the at least one grid data view may include information that relates to a corresponding position, a corresponding loan, and a corresponding earning.

In accordance with an exemplary embodiment, the method may further include receiving, via the graphical user interface, at least one first user selection on the at least one graphical element, the at least one first user selection may correspond to a request for additional information that relates to the at least one future proxy event; determining, from the event data, summary event information that corresponds to the at least one future proxy event based on a result of the mapping; and displaying, in real-time via the graphical user interface, the determined summary event information in response to the at least one first user selection.

In accordance with an exemplary embodiment, the method may further include receiving, via the graphical user interface, at least one second user selection on the at least one graphical element, the at least one second user selection may correspond to a request for portfolio information that relates to the at least one future proxy event; determining, from the event data, detailed portfolio data that corresponds to the at least one future proxy event based on a result of the mapping, the detailed portfolio data may include portfolio inventory data and loan position data; and displaying, in real-time via the graphical user interface, the detailed portfolio data in response to the at least one second user selection.

In accordance with an exemplary embodiment, the method may further include importing, via the application programming interface, quality score data, the quality score data may include at least one quality score for each of the at least one future proxy event; and updating the at least one graphical element with the at least one quality score.

In accordance with an exemplary embodiment, the at least one quality score may include a first assessment of a sustainability impact of operations based on risk exposure and a second assessment of management approaches regarding material sustainability risks along a value chain, the at least one quality score may relate to a value that represents corporate governance according to a global governance standard.

In accordance with an exemplary embodiment, the method may further include determining a ranking of the at least one future proxy event based on the event data and a predetermined criterion; generating a listing of the at least one future proxy event based on the ranking; and updating the at least one graphical element to include the generated listing of the at least one future proxy event.

According to an aspect of the present disclosure, a computing device configured to implement an execution of a method for providing proxy event visualization is disclosed. The computing device including a processor; a memory; and a communication interface coupled to each of the processor and the memory, wherein the processor may be configured to aggregate, via an application programming interface, event data from a plurality of sources, the event data may include information that relates to at least one future proxy event; parse the event data to identify at least one attribute that corresponds to each of the at least one future proxy event, the at least one attribute may include a security identifier; map each of the at least one future proxy event to at least one client portfolio based on the at least one attribute; generate at least one graphical element for each of the at least one client portfolio, the at least one graphical element may include the information that relates to the at least one future proxy event; and display, via a graphical user interface, the at least one graphical element.

In accordance with an exemplary embodiment, the at least one future proxy event may relate to an upcoming corporate action, the upcoming corporate action may include a scheduled proxy vote.

In accordance with an exemplary embodiment, the at least one graphical element may include a visual representation of a plurality of days that is organized based on a predetermined preference, the visual representation may correspond to a calendar display format.

In accordance with an exemplary embodiment, the at least one graphical element may include at least one user selectable element for each of the at least one future proxy event that hyperlinks to at least one grid data view, the at least one grid data view may include information that relates to a corresponding position, a corresponding loan, and a corresponding earning.

In accordance with an exemplary embodiment, the processor may be further configured to receive, via the graphical user interface, at least one first user selection on the at least one graphical element, the at least one first user selection may correspond to a request for additional information that relates to the at least one future proxy event; determine, from the event data, summary event information that corresponds to the at least one future proxy event based on a result of the mapping; and display, in real-time via the graphical user interface, the determined summary event information in response to the at least one first user selection.

In accordance with an exemplary embodiment, the processor may be further configured to receive, via the graphical user interface, at least one second user selection on the at least one graphical element, the at least one second user selection may correspond to a request for portfolio information that relates to the at least one future proxy event; determine, from the event data, detailed portfolio data that corresponds to the at least one future proxy event based on a result of the mapping, the detailed portfolio data may include portfolio inventory data and loan position data; and display, in real-time via the graphical user interface, the detailed portfolio data in response to the at least one second user selection.

In accordance with an exemplary embodiment, the processor may be further configured to import, via the application programming interface, quality score data, the quality score data may include at least one quality score for each of the at least one future proxy event; and update the at least one graphical element with the at least one quality score.

In accordance with an exemplary embodiment, the at least one quality score may include a first assessment of a sustainability impact of operations based on risk exposure and a second assessment of management approaches regarding material sustainability risks along a value chain, the at least one quality score may relate to a value that represents corporate governance according to a global governance standard.

In accordance with an exemplary embodiment, the processor may be further configured to determine a ranking of the at least one future proxy event based on the event data and a predetermined criterion; generate a listing of the at least one future proxy event based on the ranking; and update the at least one graphical element to include the generated listing of the at least one future proxy event.

According to an aspect of the present disclosure, a non-transitory computer readable storage medium storing instructions for providing proxy event visualization is disclosed. The storage medium including executable code which, when executed by a processor, may cause the processor to aggregate, via an application programming interface, event data from a plurality of sources, the event data may include information that relates to at least one future proxy event; parse the event data to identify at least one attribute that corresponds to each of the at least one future proxy event, the at least one attribute may include a security identifier; map each of the at least one future proxy event to at least one client portfolio based on the at least one attribute; generate at least one graphical element for each of the at least one client portfolio, the at least one graphical element may include the information that relates to the at least one future proxy event; and display, via a graphical user interface, the at least one graphical element.

In accordance with an exemplary embodiment, the at least one graphical element may include a visual representation of a plurality of days that is organized based on a predetermined preference, the visual representation may correspond to a calendar display format.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing proxy event visualization via a graphical representation to facilitate analytics of upcoming corporate events.

FIG. 4 is a flowchart of an exemplary process for implementing a method for providing proxy event visualization via a graphical representation to facilitate analytics of upcoming corporate events.

FIG. 5 is a screen shot that illustrates a graphical user interface that is usable for implementing a method for providing proxy event visualization via a graphical representation to facilitate analytics of upcoming corporate events, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

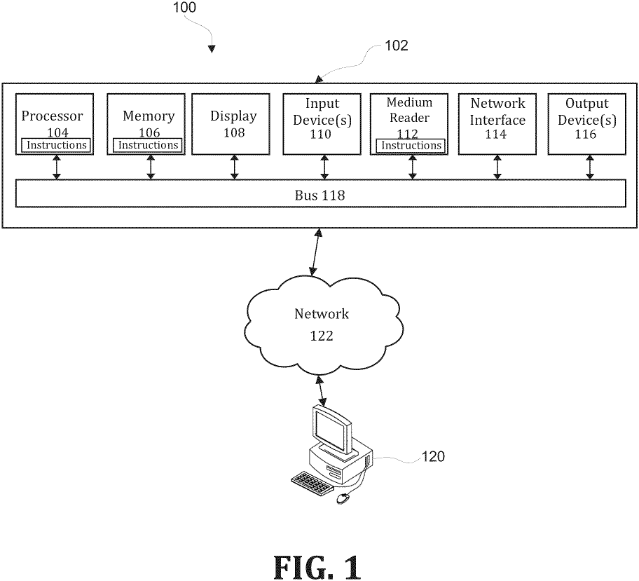

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing proxy event visualization via a graphical representation to facilitate analytics of upcoming corporate events.

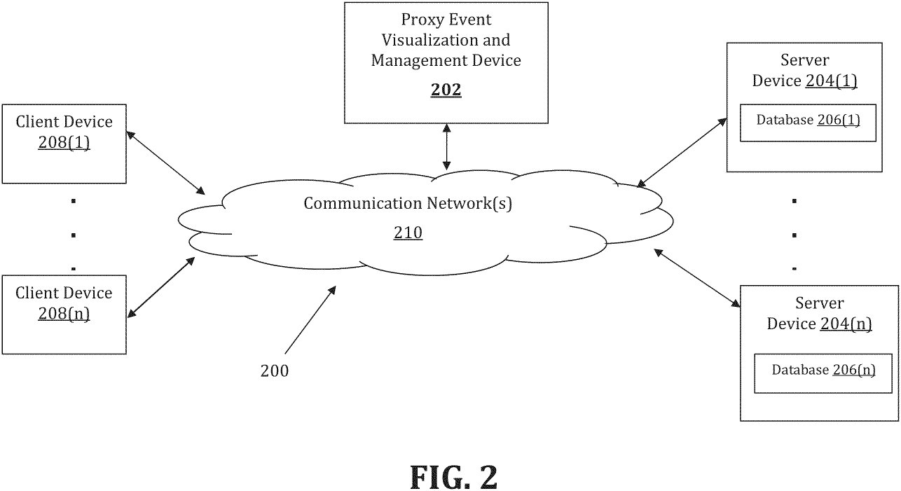

Referring to FIG. 2, a schematic of an exemplary network environment 200 for implementing a method for providing proxy event visualization via a graphical representation to facilitate analytics of upcoming corporate events is illustrated. In an exemplary embodiment, the method is executable on any networked computer platform, such as, for example, a personal computer (PC).

The method for providing proxy event visualization via a graphical representation to facilitate analytics of upcoming corporate events may be implemented by a Proxy Event Visualization and Management (PEVM) device 202. The PEVM device 202 may be the same or similar to the computer system 102 as described with respect to FIG. 1. The PEVM device 202 may store one or more applications that can include executable instructions that, when executed by the PEVM device 202, cause the PEVM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the PEVM device 202 itself, may be located in virtual server(s) running in a cloud-based computing environment rather than being tied to one or more specific physical network computing devices. Also, the application(s) may be running in one or more virtual machines (VMs) executing on the PEVM device 202. Additionally, in one or more embodiments of this technology, virtual machine(s) running on the PEVM device 202 may be managed or supervised by a hypervisor.

In the network environment 200 of FIG. 2, the PEVM device 202 is coupled to a plurality of server devices 204(1)-204(n) that hosts a plurality of databases 206(1)-206(n), and also to a plurality of client devices 208(1)-208(n) via communication network(s) 210. A communication interface of the PEVM device 202, such as the network interface 114 of the computer system 102 of FIG. 1, operatively couples and communicates between the PEVM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the PEVM device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and PEVM devices that efficiently implement a method for providing proxy event visualization via a graphical representation to facilitate analytics of upcoming corporate events.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The PEVM device 202 may be a standalone device or integrated with one or more other devices or apparatuses, such as one or more of the server devices 204(1)-204(n), for example. In one particular example, the PEVM device 202 may include or be hosted by one of the server devices 204(1)-204(n), and other arrangements are also possible. Moreover, one or more of the devices of the PEVM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the PEVM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to event data, future proxy events, attributes, security identifiers, mapping information, graphical elements, calendars, and client portfolios.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the PEVM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the PEVM device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the PEVM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the PEVM device 202, the server devices 204(1)-204(n), or the client devices 208(1)-208(n), for example, may be configured to operate as virtual instances on the same physical machine. In other words, one or more of the PEVM device 202, the server devices 204(1)-204(n), or the client devices 208(1)-208(n) may operate on the same physical device rather than as separate devices communicating through communication network(s) 210. Additionally, there may be more or fewer PEVM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

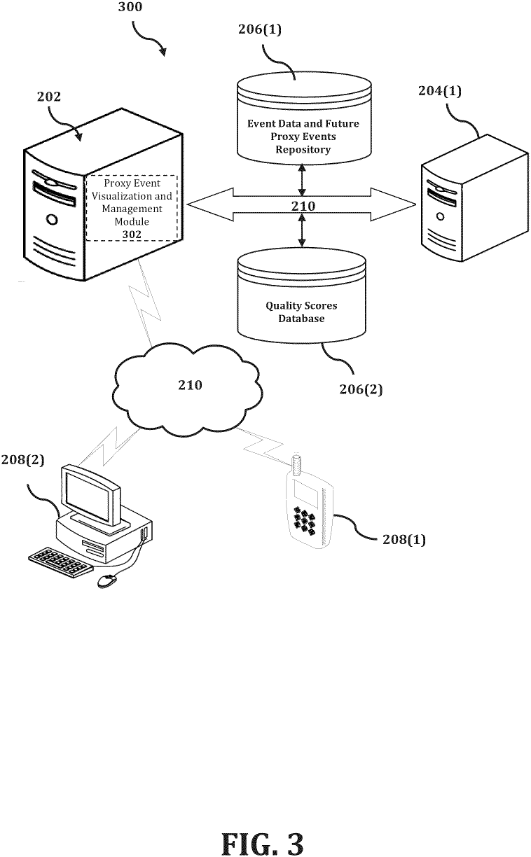

The PEVM device 202 is described and shown in FIG. 3 as including a proxy event visualization and management module 302, although it may include other rules, policies, modules, databases, or applications, for example. As will be described below, the proxy event visualization and management module 302 is configured to implement a method for providing proxy event visualization via a graphical representation to facilitate analytics of upcoming corporate events.

An exemplary process 300 for implementing a mechanism for providing proxy event visualization via a graphical representation to facilitate analytics of upcoming corporate events by utilizing the network environment of FIG. 2 is shown as being executed in FIG. 3. Specifically, a first client device 208(1) and a second client device 208(2) are illustrated as being in communication with PEVM device 202. In this regard, the first client device 208(1) and the second client device 208(2) may be “clients” of the PEVM device 202 and are described herein as such. Nevertheless, it is to be known and understood that the first client device 208(1) and/or the second client device 208(2) need not necessarily be “clients” of the PEVM device 202, or any entity described in association therewith herein. Any additional or alternative relationship may exist between either or both of the first client device 208(1) and the second client device 208(2) and the PEVM device 202, or no relationship may exist.

Further, PEVM device 202 is illustrated as being able to access an event data and future proxy events repository 206(1) and a quality scores database 206(2). The proxy event visualization and management module 302 may be configured to access these databases for implementing a method for providing proxy event visualization via a graphical representation to facilitate analytics of upcoming corporate events.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the PEVM device 202 via broadband or cellular communication. Of course, these embodiments are merely exemplary and are not limiting or exhaustive.

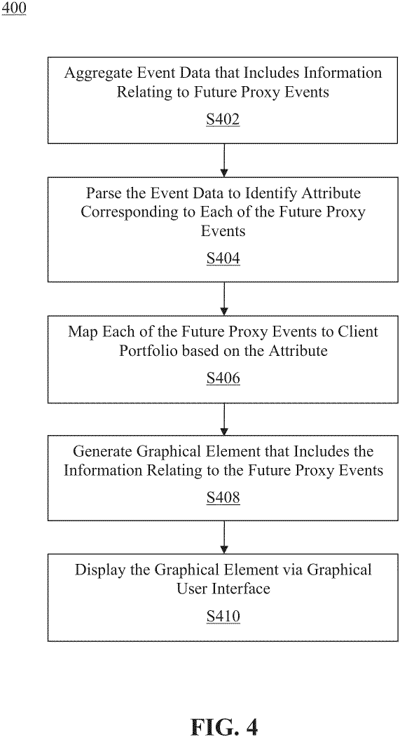

Upon being started, the proxy event visualization and management module 302 executes a process for providing proxy event visualization via a graphical representation to facilitate analytics of upcoming corporate events. An exemplary process for providing proxy event visualization via a graphical representation to facilitate analytics of upcoming corporate events is generally indicated at flowchart 400 in FIG. 4.

In the process 400 of FIG. 4, at step S402, event data may be aggregated from a plurality of sources via an application programming interface. The event data may include information that relates to future proxy events.

In an exemplary embodiment, the event data may correspond to information that relates to events such as, for example, upcoming corporate action events carried out by an entity that materially impact stakeholders of the entity such as, for example, shareholders and creditors. The upcoming corporate action events may include a scheduled voting event such as, for example, a proxy voting event that decides particular issues of the entity. The information that relates to the scheduled voting event may include statements such as, for example, proxy statements that describe the issues to be voted on. As will be appreciated by a person of ordinary skill in the art, the events may include future events as well as past events.

In another exemplary embodiment, the event data may correspond to information that relates to corporate actions carried out by an entity that materially affect securities such as, for example, equity securities and debt securities that are issued by the entity. For example, the corporate action may include at least one from among a payment of dividend action, a stock split action, a tender offer action, as well as a merger and acquisition action. The information that relates to the corporate action may include corresponding securities data such as, for example, stock data that corresponds to the stock split action. As will be appreciated by a person of ordinary skill in the art, the corporate actions may include future corporate actions as well as past corporate actions.

In another exemplary embodiment, the event data may be aggregated from a first-party data source. For example, the event data for an entity may be aggregated directly from the entity via a corresponding application programming interface. In another exemplary embodiment, the event data may be aggregated from a third-party data source. For example, the event data for several entities may be aggregated in a single instance from an external data vendor. In another exemplary embodiment, the event data may be automatically aggregated based on a predetermined schedule as well as on an ad hoc basis. For example, the event data may be automatically aggregated multiple times a day to include intraday data.

In another exemplary embodiment, the future proxy events may relate to an upcoming corporate action consistent with disclosures in the present application. The upcoming corporate action may include a scheduled proxy vote. In another exemplary embodiment, the scheduled proxy vote may relate to a ballot that is cast by a single person or a firm on behalf of shareholders of an entity. The ballot may decide particular issues related to the governance of the entity.

At step S404, the event data may be parsed to identify attributes that correspond to each of the future proxy events. In an exemplary embodiment, the parsing of the event data may correspond to a process in which a string of data is converted from one format to another. The parsing process may convert unstructured event data into a structured event data set to facilitate data identification, extraction, and analysis. In another exemplary embodiment, the parsing of the event data may correspond to a syntactic analysis process where a string of symbols is analyzed based on natural language guidelines, computer language guidelines, and/or data structure guidelines. For example, the string of symbols may be analyzed based on natural language guidelines that conform to the rules of a formal grammar.

In another exemplary embodiment, the attributes that correspond to each of the future proxy events may relate to an identifying characteristic that is usable to differentiate each of the future proxy events. The identifying characteristic may include a security identifier that is unique to each of the future proxy events. For example, future proxy event A may be associated with a security identifier that is unique to proxy event A and different from other future proxy events such as future proxy event B. In another exemplary embodiment, the security identifier may include any combination of alphabetic and numeric characters.

At step S406, each of the future proxy events may be mapped to a client portfolio based on the attributes. In an exemplary embodiment, the mapping of the future proxy events may correspond to a process of matching fields from multiple datasets to facilitate data ingestion and management. For example, data in the multiple datasets may be associated with matching fields in a centralized database. In another exemplary embodiment, the mapping of the future proxy events may correspond to a process for creating data element mappings between two distinct data models.

In another exemplary embodiment, the client portfolio may correspond to a collection of financial instruments such as, for example, stocks, bonds, commodities, cash, and cash equivalents, which includes closed-end funds and exchange traded funds. The client portfolio may include any combination of the financial instruments, which may be on loan. For example, the owner of shares or bonds may temporarily transfer the financial investments to a borrower in return for other financial instruments and/or a borrowing fee. In another exemplary embodiment, client portfolio data may be automatically aggregated consistent with disclosures in the present application for the client portfolio. The client portfolio data may include information such as, for example, position data that relates to the client portfolio. For example, the position data for the client portfolio may be automatically aggregated based on a predetermined schedule.

In another exemplary embodiment, the client portfolio may be sensitive to a set of operating standards for an entity that socially conscious investors may use to screen potential investments in the entity. The set of operating standards may relate to an environmental, social, and governance (ESG) criteria. The environmental criteria may consider how the entity performs as a steward of nature. The social criteria may examine how the entity manages relationships with employees, suppliers, customers, and the communities where the entity operates. The governance criteria may relate to leadership of the entity, executive pay, pending audit, internal control, and shareholder right.

At step S408, a graphical element for each of the client portfolios may be generated. The graphical element may include the information that relates to the corresponding future proxy events. In an exemplary embodiment, the graphical element may include a visual representation of a plurality of days that is organized based on a predetermined preference. For example, the visual representation may correspond to a calendar display format. In another exemplary embodiment, the predetermined preference may correspond to a user preference for the type of graphical element to generate and the information to be included in the graphical element. For example, the predetermined preference may reflect a user desire for a visual representation of the information that relates to the corresponding future proxy events as a monthly calendar with specific color coding.

In another exemplary embodiment, the graphical element may include a user selectable element for each of the future proxy events. Upon selection, the user selectable element may hyperlink to a grid data view of the information that relates to the corresponding future proxy events. The grid data view may include information that relates to a corresponding position, a corresponding loan, and a corresponding earning. In another exemplary embodiment, the information in the grid data view may be exportable in a variety of data formats. The user may interact with the graphical element to initiate the exporting process.

At step S410, the graphical element may be displayed via a graphical user interface. In an exemplary embodiment, the graphical user interface may include a user interface that allows users to interact with electronic devices through graphical icons. The user may perform actions in the graphical user interface through direct manipulation of the graphical elements.

In another exemplary embodiment, retrieval of summary event information may be facilitated by a first user selection on the graphical element that is received via the graphical user interface. The first user selection may correspond to a request for additional information that relates to the future proxy events. Then, summary event information that corresponds to the future proxy events may be determined from the event data. The summary event information may be determined from the event data based on a result of the mapping consistent with disclosures in the present application. Finally, the determined summary event information may be displayed in real-time via the graphical user interface in response to the first user selection.

In another exemplary embodiment, retrieval of detailed portfolio data may be facilitated by a second user selection on the graphical element that is received via the graphical user interface. The second user selection may correspond to a request for portfolio information that relates to the future proxy events. Then, detailed portfolio data that corresponds to the future proxy event may be determined from the event data. The detailed portfolio data may be determined from the event data based on a result of the mapping consistent with disclosures in the present application. The detailed portfolio data may include portfolio inventory data and loan position data. Finally, the detailed portfolio data may be displayed in real-time via the graphical user interface in response to the second user selection.

In another exemplary embodiment, quality score data may be imported via the application programming interface. The quality score data may include a quality score for each of the future proxy events. In another exemplary embodiment, the quality score may include a first assessment of a sustainability impact of operations based on risk exposure and a second assessment of management approaches regarding material sustainability risks along a value chain. The quality score may relate to a value that represents corporate governance according to a global governance standard. Then, the graphical element may be updated with the quality score data.

In another exemplary embodiment, a ranking of the future proxy events may be determined based on the event data and a predetermined criterion. The predetermined criterion may relate to a characteristic of the client portfolio such as, for example, a sensitivity to a particular type of future proxy events that requires additional attention. In another exemplary embodiment, additional position data may be aggregated for each of the future proxy events consistent with disclosures in the present application. The additional position data may include additional characteristics that correspond to the predetermined criterion such as, for example, a position size that requires closer attention. Then, a listing of the future proxy events may be generated based on the ranking. For example, a top five listing of upcoming votes may be generated to include the five most highly ranked future proxy events. Finally, the graphical element may be updated to include the generated listing of the future proxy events and corresponding position data.

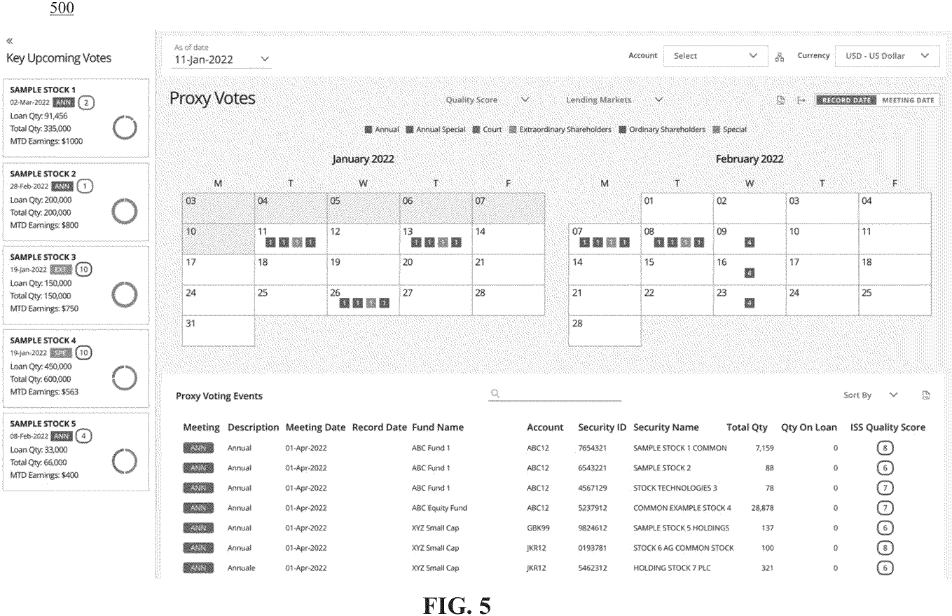

FIG. 5 is a screen shot 500 that illustrates a graphical user interface that is usable for implementing a method for providing proxy event visualization via a graphical representation to facilitate analytics of upcoming corporate events, according to an exemplary embodiment. In FIG. 5, a graphical element that is generated for the client portfolio may be visually represented as a calendar of events.

As illustrated in FIG. 5, the calendar of events may include events relating to upcoming proxy votes. Details of the upcoming proxy votes may be presented below the calendar and visually summarized as user selectable elements on the calendar. The user selectable elements may be color coded based on a user preference. In another exemplary embodiment, the calendar of events may include options to select a date range for displaying the event information. The calendar of events may also include various options to select the type of events, particular client portfolios, desired currencies, corresponding quality scores, and associated lending markets. Consistent with disclosures in the present application, the graphical element may incorporate a listing of key upcoming votes.

Accordingly, with this technology, an optimized process for providing proxy event visualization via a graphical representation to facilitate analytics of upcoming corporate events is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing proxy event visualization, the method being implemented by at least one processor, the method comprising:
aggregating, by the at least one processor via an application programming interface, event data from a plurality of sources, the event data including information that relates to at least one future proxy event;
parsing, by the at least one processor, the event data to identify at least one attribute that corresponds to each of the at least one future proxy event, the at least one attribute including a security identifier;
mapping, by the at least one processor, each of the at least one future proxy event to at least one client portfolio based on the at least one attribute;
generating, by the at least one processor, at least one graphical element for each of the at least one client portfolio, the at least one graphical element including the information that relates to the at least one future proxy event; and
displaying, by the at least one processor via a graphical user interface, the at least one graphical element.

2. The method of claim 1, wherein the at least one future proxy event relates to an upcoming corporate action, the upcoming corporate action including a scheduled proxy vote.

3. The method of claim 1, wherein the at least one graphical element includes a visual representation of a plurality of days that is organized based on a predetermined preference, the visual representation corresponding to a calendar display format.

4. The method of claim 1, wherein the at least one graphical element includes at least one user selectable element for each of the at least one future proxy event that hyperlinks to at least one grid data view, the at least one grid data view including information that relates to a corresponding position, a corresponding loan, and a corresponding earning.

5. The method of claim 1, further comprising:
receiving, by the at least one processor via the graphical user interface, at least one first user selection on the at least one graphical element, the at least one first user selection corresponding to a request for additional information that relates to the at least one future proxy event;
determining, by the at least one processor from the event data, summary event information that corresponds to the at least one future proxy event based on a result of the mapping; and
displaying, by the at least one processor in real-time via the graphical user interface, the determined summary event information in response to the at least one first user selection.

6. The method of claim 1, further comprising:
receiving, by the at least one processor via the graphical user interface, at least one second user selection on the at least one graphical element, the at least one second user selection corresponding to a request for portfolio information that relates to the at least one future proxy event;
determining, by the at least one processor from the event data, detailed portfolio data that corresponds to the at least one future proxy event based on a result of the mapping, the detailed portfolio data including portfolio inventory data and loan position data; and
displaying, by the at least one processor in real-time via the graphical user interface, the detailed portfolio data in response to the at least one second user selection.

7. The method of claim 1, further comprising:
importing, by the at least one processor via the application programming interface, quality score data, the quality score data including at least one quality score for each of the at least one future proxy event; and
updating, by the at least one processor, the at least one graphical element with the at least one quality score.

8. The method of claim 7, wherein the at least one quality score includes a first assessment of a sustainability impact of operations based on risk exposure and a second assessment of management approaches regarding material sustainability risks along a value chain, the at least one quality score relating to a value that represents corporate governance according to a global governance standard.

9. The method of claim 1, further comprising:
determining, by the at least one processor, a ranking of the at least one future proxy event based on the event data and a predetermined criterion;
generating, by the at least one processor, a listing of the at least one future proxy event based on the ranking; and
updating, by the at least one processor, the at least one graphical element to include the generated listing of the at least one future proxy event.

10. A computing device configured to implement an execution of a method for providing proxy event visualization, the computing device comprising:
a processor;
a memory; and
a communication interface coupled to each of the processor and the memory,
wherein the processor is configured to:
aggregate, via an application programming interface, event data from a plurality of sources, the event data including information that relates to at least one future proxy event;
parse the event data to identify at least one attribute that corresponds to each of the at least one future proxy event, the at least one attribute including a security identifier;
map each of the at least one future proxy event to at least one client portfolio based on the at least one attribute;
generate at least one graphical element for each of the at least one client portfolio, the at least one graphical element including the information that relates to the at least one future proxy event; and
display, via a graphical user interface, the at least one graphical element.

11. The computing device of claim 10, wherein the at least one future proxy event relates to an upcoming corporate action, the upcoming corporate action including a scheduled proxy vote.

12. The computing device of claim 10, wherein the at least one graphical element includes a visual representation of a plurality of days that is organized based on a predetermined preference, the visual representation corresponding to a calendar display format.

13. The computing device of claim 10, wherein the at least one graphical element includes at least one user selectable element for each of the at least one future proxy event that hyperlinks to at least one grid data view, the at least one grid data view including information that relates to a corresponding position, a corresponding loan, and a corresponding earning.

14. The computing device of claim 10, wherein the processor is further configured to:
receive, via the graphical user interface, at least one first user selection on the at least one graphical element, the at least one first user selection corresponding to a request for additional information that relates to the at least one future proxy event;
determine, from the event data, summary event information that corresponds to the at least one future proxy event based on a result of the mapping; and
display, in real-time via the graphical user interface, the determined summary event information in response to the at least one first user selection.

15. The computing device of claim 10, wherein the processor is further configured to:
receive, via the graphical user interface, at least one second user selection on the at least one graphical element, the at least one second user selection corresponding to a request for portfolio information that relates to the at least one future proxy event;
determine, from the event data, detailed portfolio data that corresponds to the at least one future proxy event based on a result of the mapping, the detailed portfolio data including portfolio inventory data and loan position data; and
display, in real-time via the graphical user interface, the detailed portfolio data in response to the at least one second user selection.

16. The computing device of claim 10, wherein the processor is further configured to:
import, via the application programming interface, quality score data, the quality score data including at least one quality score for each of the at least one future proxy event; and
update the at least one graphical element with the at least one quality score.

17. The computing device of claim 16, wherein the at least one quality score includes a first assessment of a sustainability impact of operations based on risk exposure and a second assessment of management approaches regarding material sustainability risks along a value chain, the at least one quality score relating to a value that represents corporate governance according to a global governance standard.

18. The computing device of claim 10, wherein the processor is further configured to:
determine a ranking of the at least one future proxy event based on the event data and a predetermined criterion;
generate a listing of the at least one future proxy event based on the ranking; and
update the at least one graphical element to include the generated listing of the at least one future proxy event.

19. A non-transitory computer readable storage medium storing instructions for providing proxy event visualization, the storage medium comprising executable code which, when executed by a processor, causes the processor to:
aggregate, via an application programming interface, event data from a plurality of sources, the event data including information that relates to at least one future proxy event;
parse the event data to identify at least one attribute that corresponds to each of the at least one future proxy event, the at least one attribute including a security identifier;
map each of the at least one future proxy event to at least one client portfolio based on the at least one attribute;
generate at least one graphical element for each of the at least one client portfolio, the at least one graphical element including the information that relates to the at least one future proxy event; and
display, via a graphical user interface, the at least one graphical element.

20. The storage medium of claim 19, wherein the at least one graphical element includes a visual representation of a plurality of days that is organized based on a predetermined preference, the visual representation corresponding to a calendar display format.
